(19) United States
(12) Patent Application Publication
(10) Pub. No.: US 2011/0217855 A1
(43) Pub. Date: Sep. 8, 2011

(54) INTERFACE DEVICE AND ELECTRONIC DEVICE ADOPTING THE SAME

(75) Inventor: Kazuyuki Yoshikoshi, Shizuoka (JP)

(73) Assignee: TOSHIBA TEC KABUSHIKI KAISHA, Tokyo (JP)

(21) Appl. No.: 12/899,717

(22) Filed: Oct. 7, 2010

(30) Foreign Application Priority Data
Mar. 4, 2010 (JP) 2010-48160

(51) Int. Cl. H01R 12/70

(52) U.S. Cl. 439/76.1; 439/55

(57) ABSTRACT

An interface device includes a board including first and second sides at opposite locations thereof. First and second connectors of different types are included. First and second connectors are mounted on the first and second sides, respectively and comply with a common communication standard. An electronic circuit mounted on the board and connected to the first and second connectors is included. The electronic circuit is adapted for data communication in compliance with the communication standard.

### CROSS-REFERENCE TO RELATED APPLICATIONS

This application is based upon and claims the benefit of priority from Japanese Patent Application No. 2010-48160, filed on Mar. 4, 2010, the entire contents of which are incorporated herein by reference.

### FIELD

Embodiments described herein relate generally to an interface device and an electronic device adopting the same.

### BACKGROUND

Generally, it is required to connect a printer to a host device through a communication cable in order for the printer to receive printing data from the host device and print out the printing data on printing paper. A communication standard for data communication between the printer and the host device, which are connected to each other through the communication cable, may include, for example, the RC-232C standard. The RC-232C based printer may include an interface device having a RS-232C based connector installed therein. This RS-232C based connector may be detachably connected to a connector installed on an end of the communication cable.

The RS-232C based connector may be classified into a 25-pin type and a 9-pin type. Typically, the printers sold by a manufacturer of a printer (referred to as “printer manufacturer”) may incorporate, in consideration of the customers' needs, various interface devices: a standard interface device having one type of connectors and optional interface devices having other different types of connectors. Thus, the printer manufacturer has to provide several optional interface devices, in addition to the standard interface device.

### BRIEF DESCRIPTION OF THE DRAWINGS

FIG. 1 is an illustrative embodiment of a plan view showing an interface device.

FIG. 2 is an illustrative embodiment of a main part of a first printer with an interface device installed.

FIG. 3 is an illustrative embodiment of a main part of a second printer with an interface device installed.

### DETAILED DESCRIPTION

According to one embodiment, an interface device may comprise a board including first and second sides at opposite locations thereof, and first and second connectors of different types. The first and second connectors may be mounted on the first and second sides, respectively and comply with a common communication standard. The interface device may further comprise an electronic circuit which is mounted on the board and connected to the first and second connectors. The electronic circuit may be adapted for data communication in compliance with the communication standard.

Hereinafter, embodiments of an interface device and an electronic device adopting the same will be described in detail with reference to the accompanying drawings.

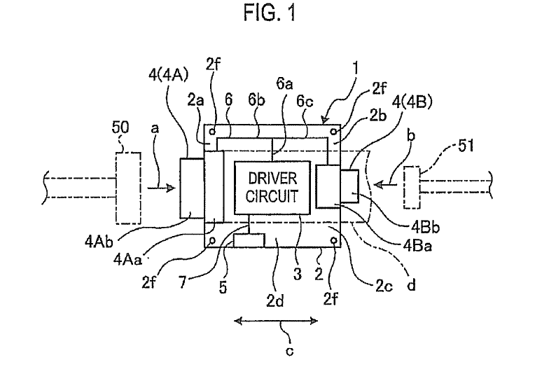

As shown in FIG. 1, an interface device 1 may include a board 2, a driver circuit 3 that is an electronic circuit, a pair of connectors (first and second connectors) 4 and a circuit coupling section 5. The driver circuit 3, pair of connectors 4 and circuit coupling section 5 may be mounted on predetermined locations of the board 2. The driver circuit 3 may be connected to the connectors 4 through a first connection line 6. The driver circuit 3 may be also connected to the circuit coupling section 5 through a second connection line 7.

The board 2 may be a printed board, which is formed, for example, in a rectangular shape. In one embodiment, the board 2 may have a pair of opposite sides 2a and 2b (first and second sides), and a third side 2d connecting the first and second sides 2a and 2b together. In this case, the third side 2d may correspond to one side of an additional pair of sides other than the opposite sides of the board 2. Further, mounting holes 2f may be provided at four corners of the board 2, respectively. The board 2 may have front and rear planes, and the driver circuit 3 and the connector 4 may be installed on one of the front and rear planes of the board 2 (e.g., plane 2c).

The driver circuit 3 may be mounted on a center portion of the board 2 and connected to the first and second connectors 4. The driver circuit 3 may be adapted for data communication with a device (not shown) connected to the first and second connectors 4 in compliance with the communication standard. Although any communication standards, such as Recommended Standard (RS)-232C, Universal Serial Bus (USB) and Centronics, that may be supported by the driver circuit 3 may be employed as the communication standard herein, one embodiment complying with the RS-232C as an example of the communication standards will be explained below. The device coupled to the connector 4, for example, may be a Point of Sales (POS) terminal, a PC and a server.

In one embodiment, the interface device 1 may include the first connector 4A at the first side 2a and the second connector 4B at the second side 2b on the board 2. For the sake of convenience, the first connector 4A and the second connector 4B may sometimes be referred to the connectors 4 in the discussions that follow.

The first and second connectors 4A and 4B may be configured to comply with the same communication standard (for example, RS-232C), and may be of the different types from each other. The first connector 4A may be a D-SUB 25-pin type, and the second connector 4B may be a D-SUB 9-pin type. Thus, a size of the first connector 4A may be bigger than that of the second connector 4B. These first and second connectors 4A and 4B may be a male-type connector or a female-type connector. In one embodiment, the types of the first and second connectors 4A and 4B may be advantageously unified to either a male type or a female type.

The first and second connectors 4A and 4B may include bases 4Aa and 4Ba, which are fixed at the board 2 and connected to the driver circuit 3. The first and second connectors 4A and 4B may further include fitting parts 4Ab and 4Bb, which project from the bases 4Aa and 4Ba, respectively. The fitting part 4Ab of the first connector 4A may be connectable to a first external connector 50. Also, the fitting part 4Bb of the second connector 4B may be connectable to a second external connector 51. In one embodiment, the first external connector 50 and the second external connector 51, which are of the different types, may comply with the same communication standard (for example, RS-232C).

The connectors 4A and 4B may be disposed at the first and second sides 2a and 2b, respectively on the board 2. For example, the first connector 4A may be disposed at the first side 2a and the second connector 4B may be disposed at the second side 2b of the board 2. Specifically, the second connector 4B may be mounted within an area formed by projecting the first connector 4A toward the direction from the first side 2a to the second side 2b (indicated by arrow “c” in FIG. 1). The first and second connectors 4A and 4B may be respectively disposed at center portions of the first and second sides 2a and 2b, or alternatively, somewhere in the extended directions of the first and second sides 2a and 2b. The first connector 4A and the second connector 4B may be installed on the bases 4Aa and 4Ba, respectively in an opposite direction to each other. The first connector 4A and the second connector 4B may be arranged such that the directions, in which the fitting parts 4Ab and 4Bb protrude from the bases 4Aa and 4Ba, respectively, may be aligned opposite and in parallel. The direction (indicated by arrow “a” in FIG. 1), in which the first external connector 50 is plugged to the first connector 4A, may be in parallel and opposite to the direction (indicated by arrow “b” in FIG. 1), in which the second external connector 51 is plugged to the second connector 4B.

The interface device 1 further may include a connection line 6. The connection line 6 may include a common line 6a connected to the driver circuit 3 and multiple branch lines. In one embodiment, the number of branch lines may be two (first and second branch lines 6b and 6c). The first and second branch lines 6b and 6c may connect the common line 6a to the respective connectors 4A and 4B. That is, the first branch line 6b may connect the first connector 4A to the common line 6a, and second branch line 6c may connect the second connector 413 to the common line 6a. With such structure, the common line 6a and the first branch line 6b may function to transfer signals between the driver circuit 3 and the first connector 4A, and the common line 6a and the second branch line 6c may function to transfer signals between the driver circuit 3 and the second connector 48.

The circuit coupling unit 5 may be structured to connect the driver circuit 3 to an additional electronic circuit through the second connection line 7. This circuit coupling unit 5 may be a land or a connector to which the second connection line 7 is connected. The circuit coupling unit 5 is disposed at a third side 2d on the board 2. Although the figure shows the circuit coupling unit 5 as being mounted out of center of the third side 2d, the position of the circuit coupling unit 5 may not be limited thereto. The circuit coupling unit 5 may be disposed at the center of the third side 2d. The interface device 1 may allow data communication with an arbitrary device connected to one of the first and second connectors 4A and 4B.

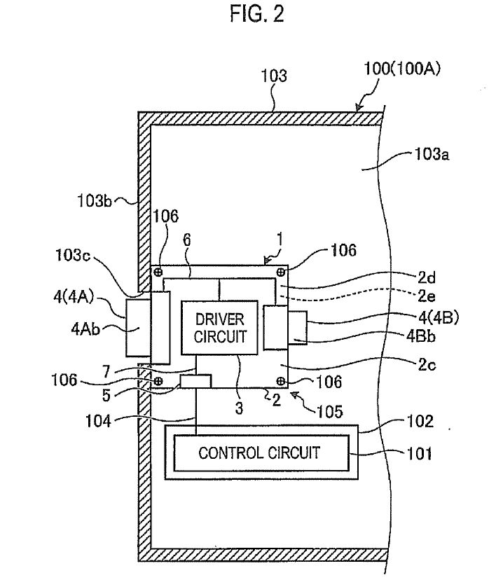

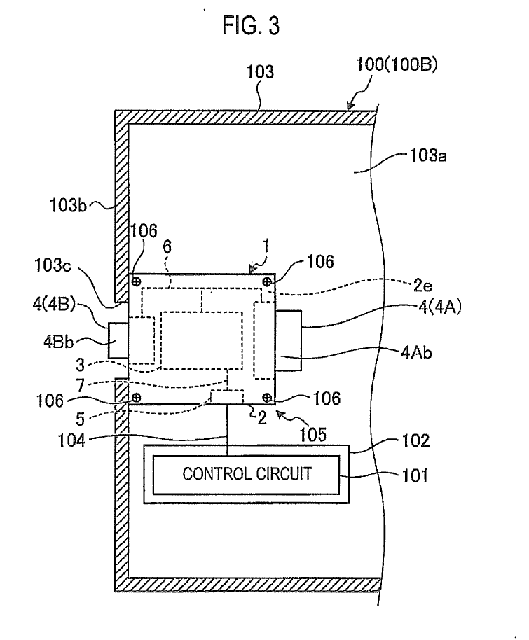

Hereinafter, an electronic device adopting the interface device will be described by way of a printer with reference to FIG. 2 and FIG. 3. As shown in FIG. 2 and FIG. 3, the printer 100a may be embodied into either a first printer 100A or a second printer 100B. Note that most of the elements included in the first and second printers 100A and 100B may be similarly configured with the exception that the mounting direction of the interface device 1 may be different. Also, for the sake of convenience, the first printer 100A and the second printer 100 may be referred to simply by the printer 100.

The printer 100 may be, for example, a thermal printer that may be operable to convey paper on a paper tray to a thermal head by a conveying unit and perform a printing operation on the conveyed d paper.

The printer 100 may include a control board 102, on which a control circuit 101 is mounted, and the interface device 1 connected to the control board 102. In this case, the control circuit 101 may be a different element from the driver circuit 3. The control circuit 101 and the driver circuit 3 may be connected to each other through a connection line 104. One end of the connection line 104 may be connected to the circuit coupling unit 5 of the interface device 1, and the other end of the connection line 104 may be connected to a serial interface unit, which may be installed on the control board 102. The connection line 104 may include, for example, a flexible harness, etc. The control circuit 101 may be operable to control the thermal head to print out printing data, which are received from a host device through the interface device 1. The control board 102, on which the control circuit 101 is installed, the interface device 1, the thermal head and the conveying unit may be accommodated in a housing 103 of the printer 100.

The housing 103 may have an opening 103c for exposing one of the connectors 4A and 4B. The housing 103 may be structured to conceal the other connector so that the interface device 1 can be substantially accommodated by the housing 103.

The printer 100 may include a supporting unit 105 mounted to support the interface device 1 in the housing 103. The supporting unit 105 may support the interface device 1 either in a first arrangement in which the first connector 4A is exposed via the opening 103e (see FIG. 2) or in a second arrangement in which the second connector 413 is exposed via the opening 103c (see FIG. 3), i.e., the board is in a turned-over state compared to its state when placed in the first arrangement. The supporting unit 105 may include four screws 106 inserted into the respective mounting holes 2f of the board 2 and four bosses (not shown) uprightly mounted on a bottom portion 103a of the housing 103. The bosses may include nuts, which are screw-coupled to the screws 106, and the supporting unit 105 may support the interface device 1 by screw-coupling the screw to the bosses.

Specifically, the interface device 1 in the first printer 100A may be built in the housing 103 such that one of planes 2c and 2e of the board 2 (e.g., plane 2e) faces the bottom portion 103a. The first connector 4A of the interface device 1 may be inserted into the opening 103c, which is formed at a side wall of the housing 103 in the first printer 100A, so that the first connector 4A may be exposed to the exterior of the housing 103. Thus, in the first printer 100A, the first connector 4A may be configured to be connectable to the first external connector 50 from the exterior, while the second connector 4B may be configured not to be connectable to the first external connector 50 from the exterior.

FIG. 3 shows the second printer 10013 in which the interface device 1 is in a turned-over state with respect to the housing 103 of the first printer 100A. Specifically, the interface device 1 in the second printer 100B may be built in the housing 103 such that one of planes 2c and 2e of the board 2 (e.g., plane 2c) faces the bottom portion 103a. The second connector 4B of the interface device 1 may be inserted into the opening 103c formed at a side wall of the housing 103 in the second printer 100B, so that the second connector 4B may be exposed to the exterior of the housing 103. Thus, in the second printer 100B, the second connector 4B may be configured to be connectable to the first external connector 50 from the exterior, while the first connector 4A may be configured not to be connectable to the first external connector 50 from the exterior.

As described above, in one embodiment, the interface device 1 may include a pair of connectors that are of the different type but comply with the same communication standard. Thus, it may not be required to design and manufacture several interface devices for respective different connectors. When multiple types of products (e.g., printers 100) are manufactured, the necessity of manufacturing multiple different types of interface devices using respectively different types of connectors may be eliminated.

In one embodiment, the interface device 1 may include the rectangular board 2, on which the driver circuit 3 may be installed, and the first and second connectors 4 may be disposed at the first and second sides 2a and 2b, respectively, on the board 2. The housing 103 of the printer 100 may include the opening 103c exposing one of the connectors 4. The housing 103 may accommodate the interface device 1. Since one of the connectors 4 may be exposed via the opening 103c of the housing 103 and the other one may not be exposed via the housing 103, only one of the connectors 4 may be usable while the other one becomes unusable. With this structure, it may be made possible to prevent both connectors from being used at the same time.

In one embodiment, the circuit coupling unit 5, which may connect the driver circuit 3 to the control circuit 101 (another electronic circuit) through the connection line 104, may be disposed at a third side 2d to which the first and second side 2a and 2b are coupled. The supporting unit 105 may support the interface device 1 either in a first arrangement in which the first connector 4A is exposed via the opening 103c (see FIG. 2) or in a second arrangement in which the second connector 4B is exposed via the opening 103c (see FIG. 3), i.e., the board 2 is in a turned-over state compared to its state when placed in the first arrangement. Thus, the interface device 1 may be built in the housing 103 such that the third side 2d and the circuit coupling unit 5 may face the control circuit 101 in whichever cases of inserting the first connector 4A into the opening 103c and inserting the second connector 4B into the opening 103c.

In one embodiment, the interface device 1 may include the common line 6a connected to the driver circuit 3 and the plurality of branch lines 6b and 6c connecting the common line 6 to the respective connectors. Thus, it may be possible to connect the driver circuit 3 to the respective connectors 4 with a relatively simple structure.

In one embodiment, the second connector 4B is disposed within an area formed by projecting the first connector 4A toward the direction from the first side 2a to the second side 2b (indicated by the arrow “c” in FIG. 1). For example, regardless of whichever connector is inserted into the opening 103c formed at the housing 103, the board 2 may be placed at an identical location in the housing 103. Thus, the supporting unit 105 may be commonly used regardless of whichever connector is inserted into the opening 103c of the housing 103.

While the present disclosure has been made of some preferred embodiments, it will be appreciated by those skilled in the art that many modifications and changes can be made without departing from the spirit and scope of the subject matter of the present disclosure. For example, although the electronic device adopting the interface device 1 has been described by way of a printer, its embodiment may not be limited thereto. The electronic device having the interface device 1 may include an electronic register, a PC, a server, etc.

Although the embodiment where the first and second connectors 4A and 4B may be disposed at the center portion of the first and second sides 2a and 2b has been described as an example of disposing the second connector 4B within an area formed by projecting the first connector 4A toward the direction from the first side 2a to the second side 2b, the way the second connector 4B is disposed with respect to the first connector 4A may not be limited thereto. That is, the first connector 4A and the second connector 4B may not be disposed at the center portion of the first and second sides 2a and 2b, but somewhere in the extended directions of the first and second sides 2a and 2b.

While certain embodiments have been described, these embodiments have been presented by way of example only, and are not intended to limit the scope of the inventions. Indeed, the novel devices described herein may be embodied in a variety of other forms; furthermore, various omissions, substitutions and changes in the form of the devices described herein may be made without departing from the spirit of the inventions. The accompanying claims and their equivalents are intended to cover such forms or modifications as would fall within the scope and spirit of the inventions.

What is claimed is:

1. An interface device comprising:
a board including first and second sides at opposite locations thereof;
first and second connectors of different types, the first and second connectors being mounted on the first and second sides, respectively and complying with a common communication standard; and
an electronic circuit mounted on the board and connected to the first and second connectors, the electronic circuit being adapted for data communication in compliance with the communication standard.

2. The device of claim 1, wherein the electronic circuit comprises a circuit coupling unit connected to another electronic circuit through a connection line, the board further includes a third side connecting the first and second sides together, and the circuit coupling unit is mounted on the third side.

3. The device of claim 1, further comprising:
a common line connected to the electronic circuit; and
branch lines connecting the common line to the first and second connectors, respectively.

4. The device of claim 1, wherein the second connector is mounted within an area formed by projecting the first connector toward a direction from the first side to the second side.

5. The device of claim 1, wherein the first and second connectors are RS-232C based connectors.

6. The device of claim 5, wherein the first connector is a D-SUB 25-pin type and the second connector is a D-SUB 9-pin type.

7. An electronic device comprising an interface device, the interface device including:
a board including first and second sides at opposite locations thereof;
first and second connectors of different types, the first and second connectors being mounted on the first and second sides, respectively and complying with a common communication standard; and
an electronic circuit mounted on the board and connected to the first and second connectors, the electronic circuit being adapted for data communication in compliance with the communication standard.

8. The device of claim 7, wherein the electronic circuit comprises a circuit coupling unit connected to another electronic circuit through a connection line, the board further includes a third side connecting the first and second sides together, and the circuit coupling unit is mounted on the third side.

9. The device of claim 7, wherein the interface device further includes:
a common line connected to the electronic circuit; and
branch lines connecting the common line to the first and second connectors, respectively.

10. The device of claim 7, wherein the second connector is mounted on the board within an area formed by projecting the first connector toward a direction from the first side to the second side.

11. The device of claim 7, wherein the first and second connectors are RS-232C based connectors.

12. The device of claim 11, wherein the first connector is a D-SUB 25-pin type and the second connector is a D-SUB 9-pin type.

13. The device of claim 7, further comprising a housing adapted to accommodate the interface device therein, the housing defining an opening adapted to expose either one of the first and second connectors.

14. The device of claim 13, further comprising:
another electronic circuit included in the housing; and
a supporting unit built the housing and structured to support the interface device,
wherein the supporting unit supports the interface device either in a first arrangement in which the first connector is exposed via the opening, or in a second arrangement in which the second connector is exposed via the opening.

15. An interface device comprising:
a board including first and second sides at opposite locations thereof, and front and rear planes;
first and second connectors of different types, the first and second connectors being mounted on the first and second sides, respectively; and
an electronic circuit mounted on one of the front and rear planes of the board and being connected to both of the first and second connectors,
wherein the interface device is adapted to be accommodated within a housing defining an opening adapted to expose one of the first and second connectors via the opening.

16. The device of claim 15, wherein the second connector is mounted within an area formed by projecting the first connector toward a direction from the first side to the second side.

17. An electronic device comprising:
an interface device comprising a board including first and second sides at opposite locations thereof, and front and rear planes, first and second connectors of different types, the first and second connectors being mounted on the first and second sides, respectively, and an electronic circuit mounted on one of the front and rear planes of the board and being connected to the first and second connectors;
a housing adapted to accommodate the interface device therein and defining an opening thereat; and
a supporting unit built in the housing and structured to support the interface device,
wherein the supporting unit supports the interface device either in a first arrangement in which the first connector is exposed via the opening or in a second arrangement in which the second connector is exposed via the opening.

18. The device of claim 17, wherein the board includes mounting holes for screw-coupling to the supporting unit.

19. An electronic device comprising:
a housing defining an opening; and
an interface device having two connectors of different types and accommodated within the housing such that one of the two connectors is exposed via the opening and the other is concealed within the housing.

20. The device of claim 19, wherein the interface device comprises a board including first and second sides at opposite locations, and the two connectors are mounted on the first and second sides of the board, respectively.
